(19) United States
(12) Patent Application Publication
(10) Pub. No.: US 2014/0020297 A1
(43) Pub. Date: Jan. 23, 2014

(54) Entry or Exit Gate System

(71) Applicant: Wanzl Metallwarenfabrik GmbH, Leiphelm (DE)

(72) Inventors: Jürgen Hämmerle, Gunzburg (DE); Peter Launer, Senden (DE)

(73) Assignee: Wanzl Metallwarenfabrik GmbH, Leiphelm (DE)

(21) Appl. No.: 13/942,940

(22) Filed: Jul. 16, 2013

(30) Foreign Application Priority Data
Jul. 17, 2012 (DE) 10 2012 106 404.0

(51) Int. Cl. E05F 15/00

(52) U.S. Cl. CPC E05F 15/0017
USPC 49/31

(57) ABSTRACT

The invention relates to an entry or exit gate system (1) with a column (2) to which a shut-off device (3) is attached, wherein a drive (4), a control system (5) and an angle measurement system (6) are provided, and wherein the entry or exit gate system (1) further has a brake (7) which acts on the shut-off device (3). The brake (7), depending on position, is driven with a variable power Px, with a sufficient braking effect nevertheless being achieved in each position.

### BACKGROUND OF THE INVENTION

The invention relates to an entry or exit gate system with the features in the preamble of the main claim. Entry or exit gate systems are part of the prior art. A system of this type has a shut-off device, which may be in the form of a gate leaf, a turnstile or other component for shutting off a space. Entry and exit gate systems with a shut-off device which are embodied as a gate leaf are described for example in publications EP 0 617 188 B1, EP 0 752 045 A1, EP 0 643 189 A1, EP 2 038 503 A1, EP 0 659 969 A1 or DE 44 32 922 C2. A shut-off device, in the form of a turnstile, is disclosed as an example by both patent specifications EP 0 456 649 B1 or EP 0 410 299 B1.

The energy consumption of such systems is not inconsiderable. Precisely if the passage is blocked by means of a shut-off device, a fairly high braking force which acts on the shut-off device is necessary for this blocking action, i.e. the drive, which is preferably integrated in the column of the system, has to make sufficient power available. In the case of a panic situation, on the other hand, i.e. if an external action of force is greater than the braking force, the blocking action is interrupted immediately. After the panic situation, the system repositions itself by means of a control system.

### BRIEF SUMMARY OF THE INVENTION

The primary object of the present invention is to improve such systems to the extent that the energy consumption can be minimised. The invention achieves this primary object with the features in the main claim. Further advantageous embodiments are described in the dependent claims.

In accordance with one form of this invention, there is provided an entry or exit gate system including a column to which a shut-off device is attached. A drive, a control system, and an angled measurement system are provided. The entry or exit gate system further includes a brake which acts on a shut-off device. The brake, depending on the position of the shut-off device, is driven with a variable power Px, with sufficient braking effect being achieved in each position of the shut-off device.

Owing to the reduction in the power input for the braking effect in the starting position or when at rest, i.e. if the shut-off device is blocking the passage, but also if the shut-off device unblocks the passage, energy can be saved. The power is provided in a variable amount and depending on the braking force requirement. The power can be adapted in known manner as follows:

1) by changing the current

2) by changing the voltage, or

3) by changing the current and voltage, or alternatively

4) using a changeable pulse duty factor of a pulse width modulation.

The position of the shut-off device is determined by means of an angle measurement system, so that the power can be adapted correspondingly. Due to this measure, the braking operations preset by the power curves can be optimised. When using a shorter gate leaf as the shut-off device, in addition the power acting can be reduced accordingly, since a lower braking force and in a panic situation a lower “panic force” is sufficient. There is also the possibility of adapting the braking force to the behaviour of the customers.

### BRIEF DESCRIPTION OF THE DRAWINGS

The invention will now be explained in greater detail using the figures, FIGS. 1 to 3 being in the form of graphs.

FIG. 1 is a graph illustrating power characteristics (P/time t) of a prior art system in the standard mode of operation.

FIG. 2 is a graph illustrating power characteristics (P/time t) of one embodiment of the invention in the standard mode of operation.

FIG. 3 is a graph illustrating power characteristics (P/time t) of one embodiment of the invention in the manipulation or panic function mode of operation.

FIG. 4 is a prospective view illustrating one embodiment of an entry or exit gate system of the invention.

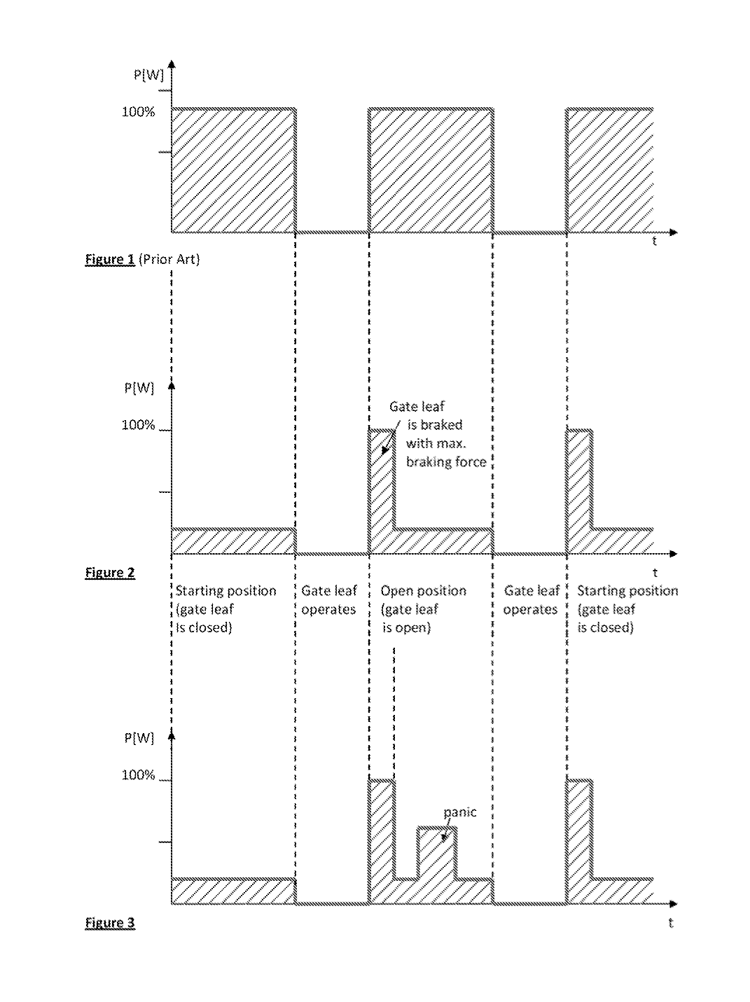

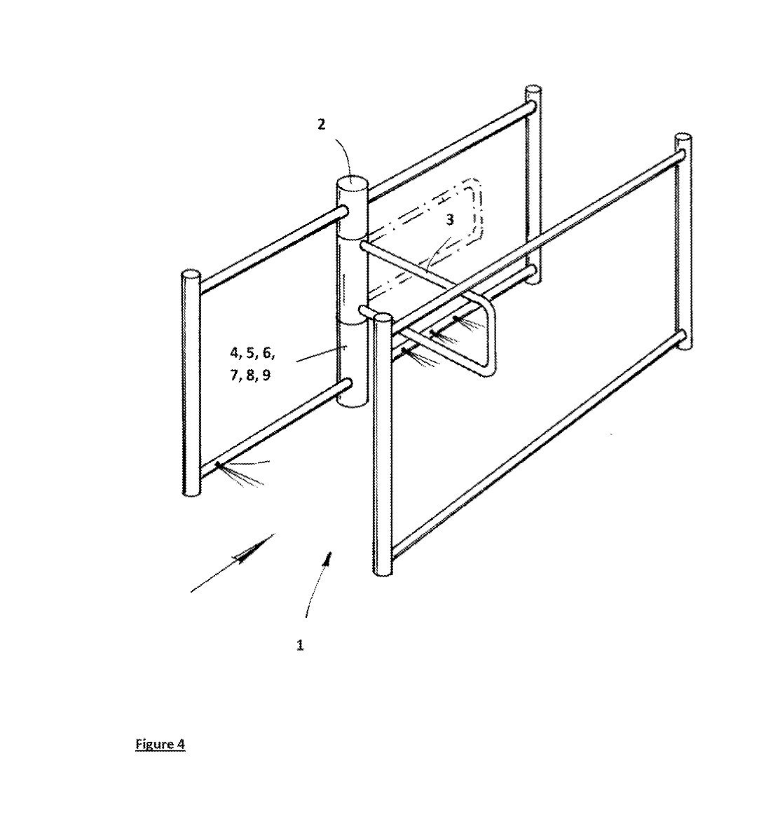

### DETAILED DESCRIPTION OF THE INVENTION

The invention relates to an entry or exit gate system 1 with a column 2, to which a shut-off device 3 is attached. Further, a drive 4, a control system 5 and an angle measurement system 6, which are known to those skilled in the art, are provided in a column located below shut-off device 3. The entry or exit gate system 1 further has a brake 7 which acts on the shut-off device 3. The brake 7, which is also known to those skilled in the art and which is also located in the column below shut-off device 3, is driven with a variable power Px depending on position of the shut-off device 3, with a sufficient braking effect being achieved in each position. The position of the shut-off device 3 is scanned by means of the angle measurement system 6, the control system 5 determining the necessary braking effect and the drive 4 then making it available. In one possible embodiment, the variable power Px is achieved via a changeable voltage U. Further, there is the possibility that the variable power Px is achieved via a changeable current intensity I. In a further embodiment, the variable power Px is achieved both via a changeable voltage U and via a changeable current intensity I. Also, the variable power Px can be provided via a changeable pulse duty factor of a pulse width modulation.

The power Px may vary, so that a range of 10-100% of the braking effect can be achieved. The braking effect may also briefly exceed the value of 100%. In a normal or panic situation, the power Px is regulated from a variable power Px first to approximately 0% power, then to approximately 100% power, and then back again to the variable power Px. Upon a manipulation of the shut-off device 3, the power Px is regulated from a variable power Px during the manipulation directly to approximately 100% power, and once the manipulation has ended is regulated back again to the variable power Px. The power Px is changeable via the control system 5, with an electrically controllable voltage source 8 or current source 9 or a pulse width modulation being able to be used, all of which are known to those skilled in the art and which also may be located in the column below shut-off device 3. The shut-off device 3 may represent a gate leaf, a turnstile or another component for shutting off a space.

In this connection, it has emerged that with a shorter gate leaf 3 less force has to be expended, and thus less power Px is necessary. With a shorter gate leaf 3 for example, thus additionally a limitation of the power Px can be pre-set by limiting the voltage U, the current intensity I or the pulse duty factor of the pulse width modulation in the control system 5. A power of Px 100% is then not absolutely necessary. This means that additionally the necessary power Px can be reduced. The power Px defines the braking effect, braking power or nominal braking power. The braking force F, the torque M and the voltage U and also the current intensity I behave analogously to the power Px, in each case with a constant electrical resistance R.

The use of a pulse width modulation, as already described above, represents an alternative. A range of 2 to 20 kHz in this case is a preferred range. A value of over 15 kHz should furthermore be preferred, since then the noise is in the non-audible range. The maximum power input Px for 100% braking power lies in a variable range between approximately 10 and 100%. Values between 5 and 60 watts have proved useful. The voltage U is a DC voltage in the range from 0 to 100%, values between 0 and 24 volts having proved useful. With regard to the current intensity I, a range between 0 and 100% is possible; values between 0 and 2.4 amperes are advantageous. An electrically driven brake 7, e.g. a solenoid brake, is used as a brake 7.

Preferred power curves are illustrated in FIGS. 1 to 3: FIG. 1 shows the power characteristic as is known from the prior art. A 100% power acts if the shut-off device 3, in this example in the form of a gate leaf, is in the starting position, i.e. blocks the passage, or alternatively briefly if the gate leaf remains in the opened position, i.e.. unblocks the passage. In contrast, the power curve of the variable power Px is illustrated in FIG. 2. In the starting position, i.e. if the gate leaf 3 is blocking the passage, a power Px of approximately 10% acts. As soon as the gate leaf 3 is opened, the power Px of the brake drops to 0%. If the gate leaf 3 has then reached the position that the passage is completely opened, the gate leaf 3 is braked with maximum braking force F, i.e. 100% of the power acts, but this then after a short time can be reduced to approximately 10%. If the gate leaf 3 should then close the passage again, the braking force F and hence the power Px are at 0%. In order that the original starting position can be assumed again, the power Px is briefly raised again to 100% and then reduced to approximately 10%.

FIG. 3 shows the power characteristic in the case of the shut-off device 3 being manipulated. This occurs e.g. when a person wishes to leave the space when the shut-off device 3 is closed, and moves the shut-off device 3 counter to the direction of travel. In this case, the braking force F is briefly increased. The power Px is raised to up to 100% or even higher. A manipulation may however also occur if the shut-off device is opened and it is to be closed forcibly. Also in this case the braking force F and hence the power Px is raised to 100% or even more than 100%. Something similar takes place during the panic function. Then too, briefly the braking force F is increased, as illustrated in FIG. 3.

The cross-hatched regions in the figures in each case represent the energy consumption. The difference between FIGS. 1 and 2 is considerable: a large amount of energy can thus be saved by the adapted and reduced power Px. Nevertheless, sufficient braking force F is exerted on the shut-off device 3, such as the gate leaf 3.

### LIST OF REFERENCE NUMERALS

1 entry or exit gate system

2 column

3 shut-off device, gate leaf

4 drive

5 control system

6 angle measurement system

7 brake

8 voltage source

9 current source

While the invention has been described in terms of the above embodiments, those skilled in the art will recognize that the invention can be practiced with modification within the spirit and scope of the appended claims.

1. An entry or exit gate system (1) comprising: a column (2) to which a shut-off device (3) is attached; a drive (4), a control system (5) and an angle measurement system (6); the entry or exit gate system (1) further including a brake (7) which acts on the shut-off device (3); the brake (7), depending on position of the shut-off device (3), is driven with a variable power Px, with a sufficient braking effect being achieved in each position of the shut-off device (3).

2. An entry or exit gate system according to claim 1, wherein the position of the shut-off device (3) is scanned by means of the angle measurement system (6), the control system (5) determining the necessary braking effect and the drive (4) providing the necessary braking effect.

3. An entry or exit gate system according to claim 1, wherein the variable power Px is achieved via a changeable voltage U.

4. An entry or exit gate system according to claim 1, wherein the variable power Px is achieved via a changeable current intensity I.

5. An entry or exit gate system according to claim 1, wherein the variable power Px is achieved both via a changeable voltage U and via a changeable current intensity I.

6. An entry or exit gate system according to claim 1, wherein the variable power Px is achieved via a changeable pulse duty factor of a pulse width modulation.

7. An entry or exit gate system according to claim 1, wherein the shut-off device (3) is a component for shutting off a space.

8. An entry or exit gate system according to claim 7, wherein the component for shutting off a space is a gate leaf.

9. An entry or exit gate system according to claim 7, wherein the component for shutting off a space is a turnstile

10. An entry or exit gate system according to claim 1, wherein the extent of the variation of the power Px results in a braking effect range of 10% to 100% or briefly greater than 100%.

11. An entry or exit gate system according to claim 1, wherein the power Px in a normal or panic situation is regulated from a variable power Px first to approximately 0% power, then to approximately 100% power and then back to the variable power Px.

12. An entry or exit gate system according to claim 1, wherein the power Px, upon a manipulation of the shut-off device (3), is regulated from a variable power Px during the manipulation directly to approximately 100% power, and once the manipulation of the shut-off device (3) has ended is regulated back to the variable power Px.

13. An entry or exit gate system according to claim 1, wherein the power Px is changeable via the control system (5), using an electrically controllable voltage source (8), current source (9) or a pulse width modulation.
